(19) United States
(12) Patent Application Publication
(10) Pub. No.: US 2017/0214046 A1
(43) Pub. Date: Jul. 27, 2017

(54) ANODE ELECTRODE MATERIAL AND LITHIUM ION BATTERY USING THE SAME

(71) Applicants: JIANGSU HUADONG INSTITUTE OF LI-ION BATTERY CO., LTD., Suzhou (CN); TSINGHUA UNIVERSITY, Beijing (CN)

(72) Inventors: Guan-Nan Qian, Suzhou (CN); Xiang-Ming He, Beijing (CN); Li Wang, Beijing (CN); Yu-Ming Shang, Beijing (CN); Jian-Jun LI, Beijing (CN); Jing Luo, Suzhou (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/481,947

(22) Filed: Apr. 7, 2017

Related U.S. Application Data
(63) Continuation of application No. PCT/CN2015/091884, filed on Oct. 13, 2015.

(30) Foreign Application Priority Data
Oct. 17, 2014 (CN) 201410552988.2

(51) Int. Cl. H01M 4/62; H01M 10/0569; C08G 73/10; H01M 4/583; C08G 73/12; H01M 10/0525; H01M 4/133

(52) U.S. Cl. CPC H01M 4/621; H01M 10/0525; H01M 10/0569; H01M 4/133; H01M 4/583; C08G 73/121; C08G 73/1078; H01M 2300/004; H01M 2004/027

(57) ABSTRACT

An anode binder includes a polymer obtained by polymerizing a maleimide type monomer with an organic diamine type compound. A lithium ion battery includes an anode electrode, an electrolyte, a separator, and an anode electrode. The anode electrode includes an anode active material, a conducting agent, and the anode binder.

### CROSS-REFERENCE TO RELATED APPLICATIONS

This application claims all benefits accruing under 35 U.S.C. §119 from China Patent Application No. 201410552988.2, filed on Oct. 17, 2014 in the State Intellectual Property Office of China, the content of which is hereby incorporated by reference. This application is a continuation under 35 U.S.C. §120 of international patent application PCT/CN2015/091884 filed on Oct. 13, 2015, the content of which is also hereby incorporated by reference.

### FIELD

The present disclosure relates to anode electrode materials and lithium ion batteries using the same.

### BACKGROUND

Binder is an important component of a cathode electrode and an anode electrode of a lithium ion battery, and is a high molecular weight compound for adhering an electrode active material to a current collector. A main role of the binder is to adhere and maintain the electrode active material, stabilize the electrode structure, and to buffer an expansion and contraction of the electrode during the charge and discharge process.

A commonly used binder in lithium ion batteries is organic fluorine-containing polymers, such as polyvinylidene fluoride (PVDF).

### BRIEF DESCRIPTION OF THE DRAWINGS

Implementations are described by way of example only with reference to the attached FIGURE.

The FIGURE is a graph showing cycling performances of Examples 2, 3 and Comparative Example 1 of lithium ion batteries.

### DETAILED DESCRIPTION

A detailed description with the above drawings is made to further illustrate the present disclosure.

In one embodiment, anode binder is provided. The anode binder is a polymer obtained by polymerizing a maleimide type monomer with an organic diamine type compound.

The maleimide type monomer comprises at least one of a maleimide monomer, a bismaleimide monomer, a multimaleimide monomer, and a maleimide type derivative monomer.

The maleimide monomer can be represented by formula I:

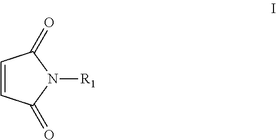

wherein R₁ is a monovalent organic substituent. More specifically, R₁ can be —R, —RNH₂R, —C(O)CH₃, —CH₂OCH₃, —CH₂S(O)CH₃, a monovalent alicyclic group, a monovalent substituted aromatic group, or a monovalent unsubstituted aromatic group, such as —C₆H₅, —C₆H₄C₆H₅, or —CH₂(C₆H₄)CH₃. R can be a hydrocarbyl with 1 to 6 carbon atoms, such as an alkyl with 1 to 6 carbon atoms. In the monovalent substituted aromatic group, an atom, such as hydrogen, can be substituted by a halogen, an alkyl with 1 to 6 carbon atoms, or a silane group with 1 to 6 carbon atoms to form the monovalent substituted aromatic group. The monovalent unsubstituted aromatic group can be phenyl, methyl phenyl, or dimethyl phenyl. A number of benzene ring in the monovalent substituted aromatic group or the monovalent unsubstituted aromatic group can be 1 to 2.

The maleimide monomer can be selected from N-phenyl-maleimide, N-(p-tolyl)-maleimide, N-(m-tolyl)-maleimide, N-(o-tolyl)-maleimide, N-cyclohexyl-maleimide, maleimide, maleimidephenol, maleimidebenzocyclobutene, dimethylphenyl-maleimide, N-methyl-maleimide, ethenyl-maleimide, thio-maleimide, ketone-maleimide, methylene-maleimide, maleimide-methyl-ether, maleimide-ethanediol, 4-maleimide-phenyl sulfone, and combinations thereof.

The bismaleimide monomer can be represented by formula II:

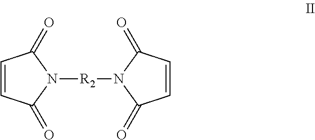

wherein R₂ is a bivalent organic substituent. More specifically, R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, substituted diphenylene, —(C₆H₄)—R₅—(C₆H₄)—, —CH₂(C₆H₄)CH₂—, or —CH₂(C₆H₄)(O)—. R₅ can be —CH₂—, —C(O)—, —C(CH₃)₂—, —O—, —O—O—, —S—, —S—S—, —S(O)—, or —(O)S(O)—. R can be a hydrocarbyl with 1 to 6 carbon atoms, such as an alkyl with 1 to 6 carbon atoms. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. A number of benzene ring in the bivalent substituted aromatic group or the bivalent unsubstituted aromatic group can be 1 to 2.

The bismaleimide monomer can be selected from N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-thiodimaleimide, N,N′-dithiodimaleimide, N,N′-ketonedimaleimide, N,N′-methylene-bismaleimide, bismaleimidomethyl-ether, 1,2-bismaleimido-1,2-ethandiol, N,N′-4,4′-diphenyl-ether-bismaleimide, 4,4′-bismaleimido-diphenylsulfone, and combinations thereof.

The maleimide type derivative monomer can be obtained by substituting a hydrogen atom of the maleimide monomer, the bismaleimide monomer, or the multimaleimide monomer with a halogen atom.

The organic diamine type compound can be represented by formula III or formula IV:

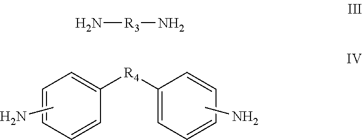

wherein R₃ is a bivalent organic substituent, and R₄ is another bivalent organic substituent.

R₃ can be —(CH₂)ₙ—, —CH₂—O—CH₂—, —CH(NH)—(CH₂)ₙ—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, or substituted diphenylene. R₄ can be —(CH₂)ₙ—, —O—, —S—, —S—S—, —CH₂—O—CH₂—, —CH(NH)—(CH₂)ₙ—, or —CH(CN)(CH₂)ₙ—. n can be 1 to 12. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. A number of benzene ring in the bivalent substituted aromatic group or the bivalent unsubstituted aromatic group can be 1 to 2.

The molecular weight of the polymer as the anode binder can be ranged from about 1000 to about 50000.

The organic diamine type compound can be selected from but is not limited to ethylenediamine, phenylenediamine, methylenedianiline, oxydianiline, and combinations thereof.

In one embodiment, the maleimide type monomer is bismaleimide, the organic diamine type compound is methylenedianiline, and the binder is represented by formula V:

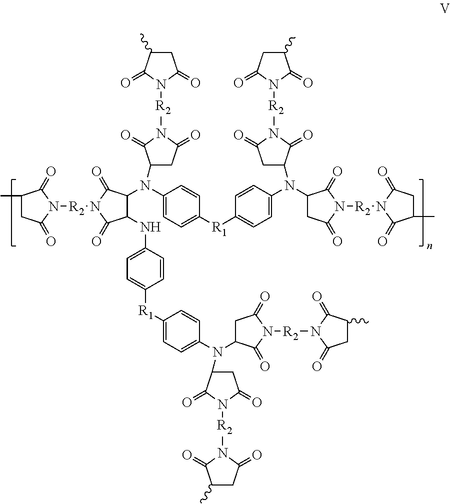

In one embodiment, a method for making the polymer comprises:

dissolving the organic diamine type compound in a solvent to form a first solution of the organic diamine type compound;

mixing the maleimide type monomer with a solvent, and then preheating to form a second solution of the maleimide type monomer; and

adding the first solution of the organic diamine type compound to the preheated second solution of the maleimide type monomer, mixing and stirring to react adequately, and obtaining the polymer.

A molar ratio of the maleimide type monomer to the organic diamine type compound can be 1:10 to 10:1, such as 1:1 to 6:1. A mass ratio of the maleimide type monomer to the solvent in the second solution of the maleimide type monomer can be 1:100 to 1:1, such as 1:10 to 1:2. The second solution of the maleimide type monomer can be preheated to a temperature of about 80□ to about 180□, such as about 80□ to about 150□. A mass ratio of the organic diamine type compound to the solvent in the first solution of the organic diamine type compound can be 1:100 to 1:1, such as 1:10 to 1:2. The first solution of the organic diamine type compound can be transported into the second solution of the maleimide type monomer at a set rate via a delivery pump, and then be stirred continuously for a set time to react adequately. The set time can be larger than 6 hours (h), such as in a range from about 12 h to about 48 h. The solvent can be organic solvent that dissolves the maleimide type monomer and the organic diamine type compound, such as gamma-butyrolactone, propylene carbonate, or N-methyl pyrrolidone (NMP). The preheating temperature range of about 80□ to about 180□ and the relatively long reacting time are to increase the branch of the polymer, such as to obtain a hyperbranched polymer, thereby obtaining a suitable viscosity for the polymer.

One embodiment of an anode electrode material comprises an anode active material, a conducting agent, and the described anode binder, which are uniformly mixed with each other. A mass percentage of the anode binder in the anode electrode material can be in a range from about 0.01% to about 50%, such as from about 1% to about 20%.

The anode active material can be selected from lithium titanate, graphite, mesophase carbon micro beads (MCMB), acetylene black, mesocarbon miocrobead, carbon fibers, carbon nanotubes, cracked carbon, and any combination thereof. The conducting agent can be carbonaceous materials, such as at least one of carbon black, conducting polymers, acetylene black, carbon fibers, carbon nanotubes, and graphite.

One embodiment of a lithium ion battery comprises a cathode electrode, an anode electrode, a separator, and an electrolyte liquid. The cathode electrode and the anode electrode are spaced from each other by the separator. The cathode electrode can further comprise a cathode current collector and a cathode electrode material located on a surface of the cathode current collector. The anode can further comprise an anode current collector and the anode electrode material located on a surface of the anode current collector. The anode electrode material and the cathode electrode material are opposite to each other and spaced by the separator.

The cathode electrode material can comprise a cathode active material, and can further comprise a conducting agent and a binder. The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

The conducting agent in the cathode electrode material can be carbonaceous materials, such as at least one of carbon black, conducting polymers, acetylene black, carbon fibers, carbon nanotubes, and graphite. The cathode binder can be at least one of polyvinylidene fluoride (PVDF), polyvinylidene fluoride, polytetrafluoroethylene (PTFE), fluoro rubber, ethylene oropylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate (EC), diethyl carbonate (DEC), propylene carbonate (PC), dimethyl carbonate (DMC), ethyl methyl carbonate (EMC), butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### EXAMPLES

### Example 1

4 g of bismaleimide (BMI) and 2.207 g of methylenedianiline are separately dissolved in the γ-butyrolactone to form a bismaleimide solution and a methylenedianiline solution. The oxygen is removed from the solutions. The bismaleimide solution is heated to about 130° C. The methylenedianiline solution is added to the bismaleimide solution drop by drop, and the mixed solution is kept at about 130° C. for about 24 hours to carry the polymerization. After being cooled, the product is precipitated in methanol, washed, and dried to obtain the anode binder represented by formula V.

### Example 2

80% of MCMB, 10% of the anode binder obtained in Example 1, and 10% of the acetylene black by mass percent are mixed and dispersed by the NMP to form a slurry. The slurry is coated on an copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 3

85% of MCMB, 5% of the anode binder obtained in Example 1, and 10% of the acetylene black by mass percent are mixed and dispersed by the NMP to form a slurry. The slurry is coated on an copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Comparative Example 1

80% of MCMB, 10% of the PVDF, and 10% of the acetylene black by mass percent are mixed and dispersed by the NMP to form a slurry. The slurry is coated on an copper foil and vacuum dried at about 120° C. for about 12 hours to obtain the anode electrode.

### Comparative Example 2

Bismaleimide (BMI) and barbituric acid having a molar ratio of about 2:1 are dissolved in NMP heated at about 130° C. for about 24 hours to carry the polymerization. After being cooled, the product is precipitated in methanol, washed, and dried to obtain a polymer.

### Comparative Example 3

80% of MCMB, 10% of the polymer obtained in Comparative Example 2, and 10% of the acetylene black by mass percent are mixed and dispersed by the NMP to form a slurry. The slurry is coated on a copper foil and vacuum dried at about 120° C. for about 12 hours to obtain the anode electrode.

Solubility Test

The polymers obtained in Example 1 and Comparative Example 2 are respectively dissolved in different organic solvents. The solubility test results are shown in Table 1. The polymer formed in Example 1 is substantially insoluble to each of ethyl acetate, tetrahydrofuran, and acetone. The polymer formed in Comparative Example 2 is slightly soluble or partially soluble to each of ethyl acetate, tetrahydrofuran, and acetone. The polymers obtained both in Example 1 and Comparative Example 2 are completely soluble to the solvent with a strong polarity, such as NMP.

TABLE 1

| | ethyl | tetra- | | | N,N-dimethyl- |
|---|---|---|---|---|---|
| | acetate | hydrofuran | acetone | NMP | formamide |
| Example 1 | X | X | X | ◯ | ◯ |
| Comparative | + | + | ++ | ◯ | ◯ |
| Example 2 | | | | | |

X—insoluble,
+—slightly soluble,
++—partially soluble,
◯—completely soluble

Binding Force Test

The binding force tests are carried out for the anode electrodes of Example 2, Comparative Example 1, and Comparative Example 3, respectively. Adhesive tape having a width of 20 mm±1 mm is used. First, 3 to 5 outer layers of the adhesive tape are peeled off, and then more than 150 mm long of the adhesive tape is taken (the adhesive tape cannot contact with hand or other objects). One end of the adhesive tape is adhered to the cathode electrode, and the other end of the adhesive tape is connected to a holder. A roller under its own weight is rolled on the cathode electrode at a speed of about 300 mm/min back and forth three times. The test is carried out after resting the cathode electrode in the test environment for about 20 minutes to about 40 minutes. The adhesive tape is peeled from the cathode electrode by a testing machine at a speed of about 300 mm/min±10 mm/min. The test results are shown in Table 2, revealing that although the conventional PVDF (Comparative Example 1) has a stronger binding force, the cathode electrode of Example 2 also has a sufficient binding force to combine the cathode active material with the conducting agent and form a stable layer on the cathode current collector in the lithium ion battery. However, the cathode electrode of Comparative Example 3 barely has a binding force.

TABLE 2

| | Sample | Sample | Maximum |
|---|---|---|---|
| Sample | Thickness/μm | Width/mm | load/N |
| Example 2 | 64 ± 2 | 20 | 0.176 |
| Comparative | 64 ± 2 | 20 | 0.183 |
| Example 1 | | | |
| Comparative | 64 ± 2 | 20 | 0 |
| Example 3 | | | |

Liquid Absorption Rate Test

The pristine anode electrodes of Example 2 and Comparative Example 1 are first weighed, and then immersed in an electrolyte liquid for about 48 hours. The anode electrodes are weighed again after removing the anode electrodes from the electrolyte liquid, and wiping off the residual electrolyte liquid on the surface of the anode electrodes. Liquid absorption rate (R) is calculated by the equation 1: R=(M_{after}−M_{before})/M_{before}×100%, wherein M_{before} is the mass of the anode electrode before being immersed in the electrolyte liquid, and M_{after} is the mass of the anode electrode after being immersed in the electrolyte liquid. The R value for Example 2 is 15.9%, and the R value for Comparative Example 1 is 21.0%, which reveal that although the anode electrode using the conventional PVDF (Comparative Example 1) has a higher liquid absorption rate, the anode electrode of Example 2 also has a sufficient liquid absorption rate to meet the liquid absorption rate requirement for a separator in the lithium ion battery.

Electrochemical Performance Test

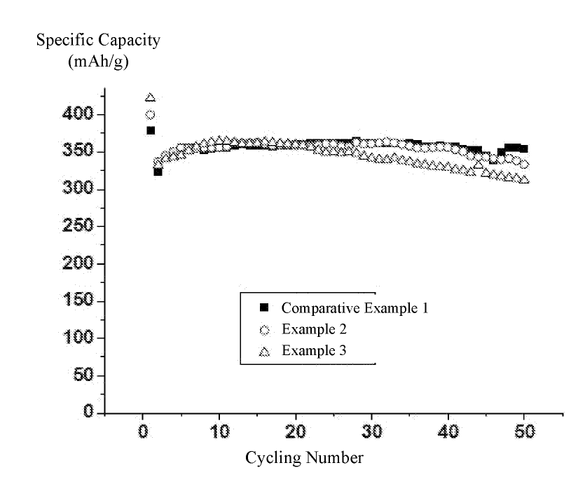

Referring to FIG. 1 and Table 3, the lithium ion batteries of Examples 2, 3 and Comparative Example 1 are subjected to a cycling performance test. The test conditions are as follows: in the voltage range of 0.005V to 2V, the batteries are charged and discharged at a constant current rate (C-rate) of 0.1 C. The cycling performances of the batteries for the first 50 cycles are shown in FIG. 1. The efficiency at first cycle, the discharge specific capacity of the 50^{th} cycle, and the capacity retention at the 50^{th} cycle are shown in Table 3. It can be seen that the lithium ion batteries using the polybismaleimide anode binder and the PVDF binder have the similar cycling performance.

TABLE 3

| | | Discharge specific | Capacity |
|---|---|---|---|
| | Efficiency | capacity of the | retention |
| | at 1st cycle | 50^{th} cycle | at the |
| | (%) | (mAh/g) | 50^{th} cycle |
| Example 2 | 71% | 335 | 99.4% |
| Example 3 | 70% | 312 | 93.9% |
| Comparative | 87% | 354 | 100% |
| Example 1 | | | |

In the present disclosure, the polymer obtained by polymerizing the maleimide type monomer with the organic diamine type compound can be used as an anode binder in the lithium ion battery. The polymer has a sufficient binding force, and a small effect on the charge and discharge cycling performance of the lithium ion battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An anode electrode material comprising an anode binder, wherein the anode binder comprises a polymer obtained by polymerizing a maleimide type monomer with an organic diamine type compound;
the maleimide type monomer is selected from the group consisting of maleimide monomer, bismaleimide monomer, multimaleimide monomer, maleimide type derivative monomer, and combinations thereof; and
the organic diamine type compound is represented by formula III or formula IV: 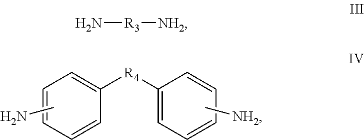
wherein R₃ is a bivalent organic substituent and R₄ is another bivalent organic substituent.

2. The anode electrode material of claim 1, wherein R₃ is selected from the group consisting of —(CH₂)ₙ—, —CH₂—O—CH₂—, —CH(NH)—(CH₂)ₙ—, phenylene, diphenylene, substituted phenylene, substituted diphenylene, and bivalent alicyclic group, R₄ is selected from the group consisting of —(CH₂)ₙ—, —O—, —S—, —S—S—, —CH₂—O—CH₂—, —CH(NH)—(CH₂)ₙ—, and —CH(CN)(CH₂)ₙ—, and n=1 to 12.

3. The anode electrode material of claim 1, wherein the organic diamine type compound is selected from the group consisting of ethylenediamine, phenylenediamine, methylenedianiline, oxydianiline, and combinations thereof.

4. The anode electrode material of claim 1, wherein the maleimide monomer is represented by formula I: 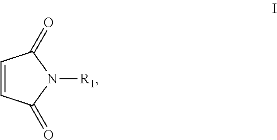
wherein R₁ is a monovalent organic substitute.

5. The anode electrode material of claim 4, wherein Ri is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, and monovalent alicyclic group; R is hydrocarbyl with 1 to 6 carbon atoms.

6. The anode electrode material of claim 1, wherein the maleimide monomer is selected from the group consisting of N-phenyl-maleimide, N-(p-tolyl)-maleimide, N-(m-tolyl)-maleimide, N-(o-tolyl)-maleimide, N-cyclohexyl-maleimide, maleimide, maleimidephenol, maleimidebenzocyclobutene, dimethylphenyl-maleimide, N-methyl-maleimide, ethenyl-maleimide, thio-maleimide, ketone-maleimide, methylene-maleimide, maleimide-methyl-ether, maleimide-ethanediol, 4-maleimide-phenyl sulfone, and combinations thereof.

7. The anode electrode material of claim 1, wherein the bismaleimide monomer is represented by formula II: 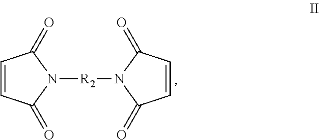
wherein R₂ is a bivalent organic substitute.

8. The anode electrode material of claim 7, wherein R₂ is selected from the group consisting of —R—, —RNH₂R—, —C(O)CH₂—, —CH₂OCH₂, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)(O)—, —R—Si(CH₃)₂—O—Si(CH₃)₂—R—, —C₆H₄—, —C₆H₄C₆H₄—, bivalent alicyclic group or —(C₆H₄)—R₅—(C₆H₄)—; R₅ is —CH₂—, —C(O)—, —C(CH₃)₂, —O—, —O—O—, —S—, —S—S—, —S(O)—, and —(O)S(O)—; and R is hydrocarbyl with 1 to 6 carbon atoms.

9. The anode electrode material of claim 1, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-thiodimaleimide, N,N′-dithiodimaleimide, N,N′-ketonedimaleimide, N,N′-methylene-bismaleimide, bismaleimidomethyl-ether, 1,2-bismaleimido-1,2-ethandiol, N,N′-4,4′-diphenyl-ether-bismaleimide, 4,4′-bismaleimido-diphenylsulfone, and combinations thereof.

10. The anode electrode material of claim 1, wherein a molecular weight of the polymer is in a range from about 1000 to about 50000.

11. The anode electrode material of claim 1, wherein a molar ratio of the maleimide type monomer to the organic diamine type compound is 1:10 to 10:1.

12. The anode electrode material of claim 1, wherein a molar ratio of the maleimide type monomer to the organic diamine type compound is 1:1 to 6:1.

13. The anode electrode material of claim 1, wherein a mass percent of the anode binder in the anode electrode material is in a range from about 0.1% to about 50%.

14. The anode electrode material of claim 1, wherein a mass percent of the anode binder in the anode electrode material is in a range from about 1% to about 20%.

15. The anode electrode material of claim 1, wherein the anode binder is consisted of the polymer.

16. The anode electrode material of claim 1, further comprises an anode active material selected from the group consisting of lithium titanate, graphite, mesophase carbon micro beads, acetylene black, mesocarbon miocrobead, carbon fibers, carbon nanotubes, cracked carbon, and combinations thereof.

17. A lithium ion battery comprising:
a cathode electrode;
an electrolyte;
a separator; and
an anode electrode, the anode electrode comprising a anode active material, a conducting agent, and a anode binder,
wherein the anode binder comprises a polymer obtained by polymerizing a maleimide type monomer with an organic diamine type compound;
the maleimide type monomer is selected from the group consisting of maleimide monomer, bismaleimide monomer, multimaleimide monomer, maleimide type derivative monomer, and combinations thereof; and
the organic diamine type compound is represented by formula III or formula IV: 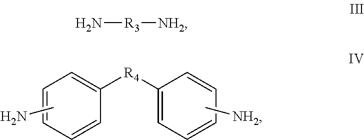
wherein R₃ is a bivalent organic substituent and R₄ is another bivalent organic substituent.
